(19) United States
(12) Patent Application Publication
(10) Pub. No.: US 2023/0126201 A1
(43) Pub. Date: Apr. 27, 2023

(54) PROCESS EXECUTION ORDER DETERMINING PROGRAM AND PROCESS EXECUTION ORDER DETERMINING METHOD

(71) Applicant: DAIKIN INDUSTRIES, LTD., Osaka (JP)

(72) Inventor: Kousuke KIBO, Osaka (JP)

(21) Appl. No.: 17/907,446

(22) PCT Filed: Mar. 26, 2021
(86) PCT No.: PCT/JP2021/013085

§ 371 Date: Sep. 27, 2022

(30) Foreign Application Priority Data
Mar. 31, 2020 (JP) 2020-062593

(51) Int. Cl. G06F 9/48; G06F 9/38

(52) U.S. Cl. CPC G06F 9/4887; G06F 9/3897

(57) ABSTRACT

The present disclosure provides a process execution order determining program and a process execution order determining method for supporting work in determining the execution order of a plurality of processes when designing the plurality of processes to be executed in controlled devices. The process execution order determining program causes a computer to execute a decision process for determining an execution order of a plurality of processes to be executed in controlled devices; and a first determination process for monitoring elements that appear in a connection path formed in the decision process, and determining whether same elements appear in the connection path.

### TECHNICAL FIELD

The present disclosure relates to a process execution order determining program and a process execution order determining method.

### BACKGROUND ART

Generally, when designing a plurality of processes to be executed in controlled devices, the designer determines the execution order of the plurality of processes by grasping the processing contents of the plurality of processes.

For example, Patent Document 1 below proposes a configuration in which the execution order is determined by automatically associating processes with one another based on the input/output relationship between the processes.

### RELATED-ART DOCUMENTS

### Patent Documents

Patent Document 1: Japanese Laid-Open Patent Publication No. 2004-521402

### SUMMARY OF THE INVENTION

### Problem to be Solved by the Invention

In order to correctly execute a plurality of processes in controlled devices, the execution order of the processes needs to be appropriately determined. Therefore, not only the processes are associated with one another based on the input/output relationship, but also the processes are required to be associated with one another without any inconsistency. However, the workload of a designer in checking whether the processes are associated with one another without any inconsistency is large.

The present disclosure provides a process execution order determining program and a process execution order determining method for supporting work in determining the execution order of a plurality of processes when designing the plurality of processes to be executed in controlled devices.

### Means to Solve the Problem

A first aspect of the present disclosure provides a process execution order determining program for causing a computer to execute:
a decision process for determining an execution order of a plurality of processes to be executed in controlled devices; and
a first determination process for monitoring elements that appear in a connection path formed in the decision process, and determining whether same elements appear in the connection path.

The first aspect of the present disclosure can provide a process execution order determining program for supporting work in determining the execution order of a plurality of processes when designing the plurality of processes to be executed in controlled devices.

A second aspect of the present disclosure provides the process execution order determining program according to the first aspect, wherein the elements include either the processes or variables, the variables being included in processing contents of the processes.

A third aspect of the present disclosure provides the process execution order determining program according to the first aspect, wherein the decision process includes determining the execution order by using input variables and output variables to connect the plurality of processes so as to form the connection path with an input item and an output item for entirety of the plurality of processes being set as a start end and a termination end, the input variables and output variables being extracted from the plurality of processes.

A fourth aspect of the present disclosure provides the process execution order determining program according to the first aspect, wherein the decision process includes creating a matrix indicating a relationship between the plurality of processes and variables included in processing contents of the plurality of processes, identifying a connection relationship between processes through a variable from a calculation result of the power of the matrix, and determining the execution order based on the connection relationship.

A fifth aspect of the present disclosure provides the process execution order determining program according to the fourth aspect, wherein the matrix is an adjacency matrix of a directed graph in a case where the plurality of processes and the variables included in the processing contents of the plurality of processes are regarded as vertices in graph theory, and input and output relationships between the processes and the variables included in the processes are regarded as directed edges.

A sixth aspect of the present disclosure provides the process execution order determining program according to the first aspect, wherein the first determination process includes indicating a determination result in response to determining that the same elements appear in the connection path.

A seventh aspect of the present disclosure provides the process execution order determining program according to any one of the third to fifth aspects, further causing the computer to execute
a first acquiring process for acquiring the input item and the output item for the entirety of the plurality of processes,
a second acquiring process for acquiring processing contents of the plurality of processes, and
an extracting process for extracting the input variables and the output variables from the processing contents of the plurality of processes acquired in the second acquiring process.

An eighth aspect of the present disclosure provides the process execution order determining program according to any one of the third to fifth aspects, further causing the computer to execute
a second determination process for determining whether a given variable included in processing contents of the plurality of processes is updated by two or more processes, and
a notification process for sending a notification in response to determining that the given variable is updated by the two or more processes in the second determination process.

A ninth aspect of the present disclosure provides the process execution order determining program according to any one of the third to fifth aspects, further causing the computer to execute
a third determination process for determining whether there is a variable that is not updated by any of the processes from among variables included in processing contents of the processes, and
a notification process for sending a notification in response to determining that there is the variable that is not updated by any of the processes in the third determination process.

A tenth aspect of the present disclosure provides a process execution order determining method including:
a decision process for determining an execution order of a plurality of processes to be executed in controlled devices; and
a determination process for monitoring elements that appear in a connection path formed in the decision process, and determining whether same elements appear in the connection path.

The tenth aspect of the present disclosure can provide a process execution order determining method for supporting work in determining the execution order of a plurality of processes when designing the plurality of processes to be executed in controlled devices.

### BRIEF DESCRIPTION OF THE DRAWINGS

FIG. 1 is a diagram illustrating an example of a usage scenario of a design work support apparatus;

FIG. 2 is a diagram illustrating an example of a hardware configuration of the design work support apparatus;

FIG. 3 is a flowchart illustrating a flow of an execution order determining process;

FIG. 4 is a diagram illustrating an outline of the execution order determining process;

FIG. 5 is a diagram illustrating an example of a functional configuration of the process execution order determining unit;

FIG. 6 is a first diagram illustrating a specific example of a process performed by a description unit;

FIG. 7 is a second diagram illustrating the specific example of the process performed by the description unit;

FIG. 8 is a first diagram illustrating a specific example of a process performed by an analysis unit;

FIG. 9 is a second diagram illustrating the specific example of the process performed by the analysis unit;

FIG. 10 is a flowchart illustrating a flow of a decision process and a circular reference determining process;

FIG. 11 is a first diagram illustrating a specific example of a process performed by a decision unit;

FIG. 12 is a second diagram illustrating the specific example of the process performed by the decision unit;

FIG. 13 is a third diagram illustrating the specific example of the process performed by the decision unit;

FIG. 14 is a diagram illustrating a specific example of a process performed by a determination unit;

FIG. 15 is a first diagram illustrating a specific example of a process performed by a check unit;

FIG. 16 is a second diagram illustrating the specific example of the process performed by the check unit;

FIG. 17 is a diagram illustrating a specific example of a process performed by a notification unit;

FIG. 18 is a first diagram illustrating a specific example of a process for identifying the connection relationship between processes; and

FIG. 19 is a second diagram illustrating the specific example of the process for identifying the connection relationship between the processes.

### MODE FOR CARRYING OUT THE INVENTION

In the following, embodiments will be described with reference to the accompanying drawings. In the specification and drawings, elements having substantially the same functions or configurations are referred to by the same numerals and the description thereof will not be repeated.

### First Embodiment

### Usage Scenario of Design Work Support Apparatus

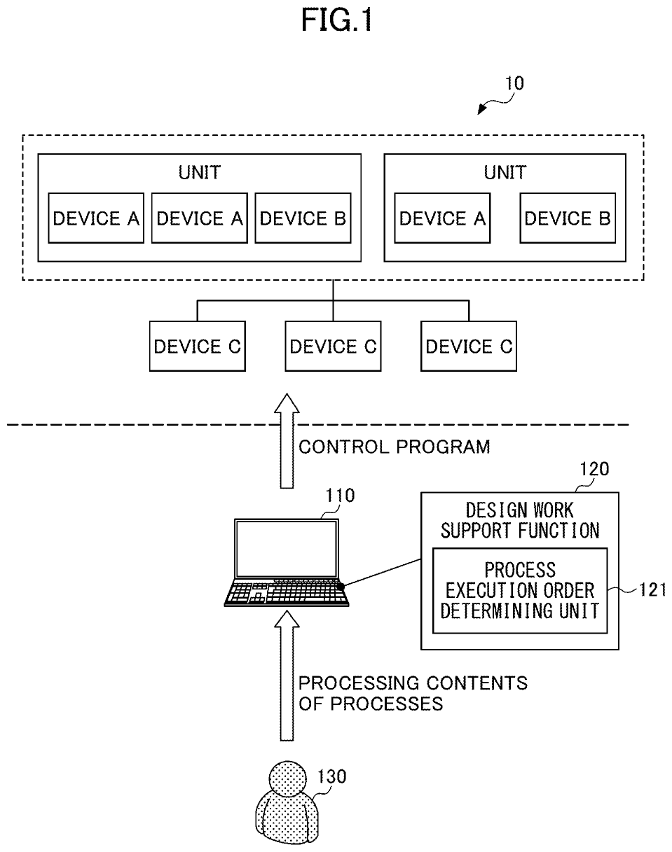

First, a usage scenario of a design work support apparatus when designing a plurality of processes to be executed in controlled devices will be described. FIG. 1 is a diagram illustrating an example of a usage scenario of a design work support apparatus. As illustrated in FIG. 1, for example, the design work support apparatus 110 provides a device system 10 with a control program for a plurality of processes to be executed in controlled devices that are included in the device system 10.

In FIG. 1, the device system 10 includes a plurality of units. In each of the units, a plurality of types of devices (device(s) A and device(s) B) operate in cooperation with other devices (devices C) located outside the units. However, the system configuration of the device system 10, to which the control program is provided by the design work support apparatus 110, may be any configuration, and is not limited to the configuration illustrated in the example of FIG. 1.

A design work support program is installed in the design work support apparatus 110, and the design work support apparatus 110 implements a design work support function 120 by executing the design work support program.

The design work support program includes a subprogram (for example, a process execution order determining program) for implementing a plurality of subfunctions. When the design work support program is executed, the subprogram is also executed. That is, the plurality of subfunctions of the design work support function 120 include a process execution order determining unit 121.

The process execution order determining unit 121 determines the execution order of a plurality of processes to be executed in one loop (For example, in a cycle of 0.5 seconds) based on processing contents entered as descriptions by a user 130. When determining the execution order, the process execution order determining unit 121 determines or checks whether there is any inconsistency between processes (determines or checks the accuracy). Therefore, when designing a plurality of processes to be executed in the controlled devices, the user 130 can associate the processes with one another without any inconsistency, and can appropriately determine the execution order of the processes.

Because the design work support function 120 has the plurality of subfunctions, the design work support function 120 can provide the control program that is for a plurality of processes to be executed in the controlled devices that are included in the device system 10

### Hardware Configuration of Design Work Support Apparatus

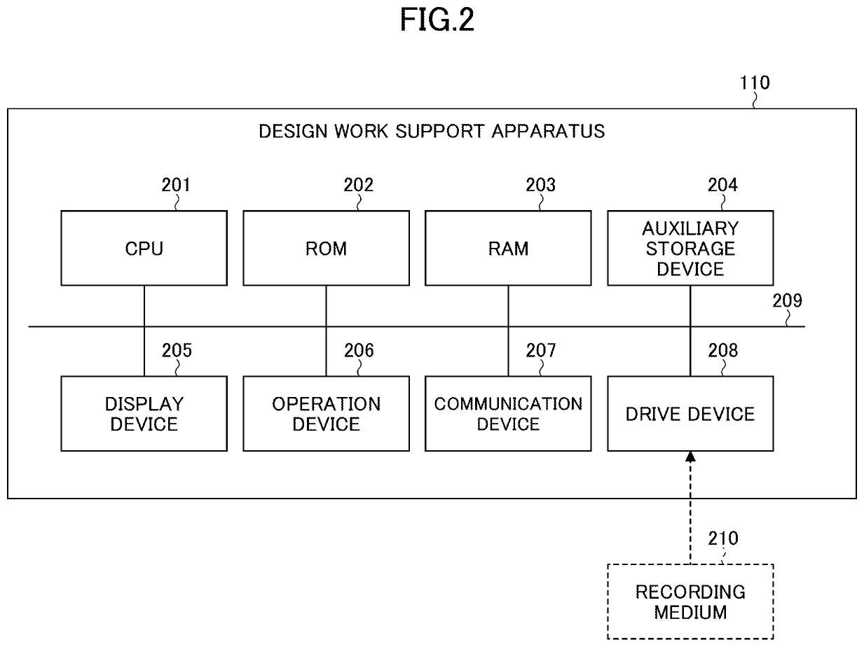

Next, a hardware configuration of the design work support apparatus 110 will be described. FIG. 2 is a diagram illustrating an example of a hardware configuration of the design work support apparatus.

As illustrated in FIG. 2, the design work support apparatus 110 includes a central processing unit (CPU) 201, a read-only memory (ROM) 202, and a random-access memory (RAM) 203. The CPU 201, the ROM 202, and the RAM 203 constitute what is known as a computer.

Further, the design work support apparatus 110 includes an auxiliary storage device 204, a display device 205, an operation device 206, a communication device 207, and a drive device 208. Note that the hardware components of the design work support apparatus 110 are connected with one another via a bus 209.

The CPU 201 is a calculation device that executes various programs (for example, the design work support program and the like) installed in the auxiliary storage device 204.

The ROM 202 is a non-volatile memory. The ROM 202 functions as a main storage device that stores various programs, data, and the like necessary for the CPU 201 to execute various programs installed in the auxiliary storage device 204. Specifically, the ROM 202 functions as a main storage device that stores a boot program or the like, such as a basic input/output system (BIOS) or an extensible firmware interface (EFI).

The RAM 203 is a volatile memory such as a dynamic random-access memory (DRAM) or a static random-access memory (SRAM). The RAM 203 functions as a main storage device that provides a work area in which various programs installed in the auxiliary storage device 204 are loaded when executed by the CPU 201.

The auxiliary storage device 204 is an auxiliary storage device that stores various programs and information used when the various programs are executed.

The display device 205 is a display device that displays an internal state of the design work support apparatus 110. The operation device 206 is an input device used when the user 130 of the design work support apparatus 110 inputs various instructions into the design work support apparatus 110.

The communication device 207 is a communication device that is connected to a network (not illustrated) and performs communication.

The drive device 208 is a device in which a recording medium 210 is set. The recording medium 210 includes a medium for optically, electrically, or magnetically recording information, such as a CD-ROM, a flexible disk, or a magneto-optical disc. Further, the recording medium 210 may include a semiconductor memory or the like that electrically records information, such as a ROM, a flash memory, or the like.

Various programs to be installed in the auxiliary storage device 204 are installed by, for example, setting the distributed recording medium 210 in the drive device 208 and reading the various programs recorded in the recording medium 210 by the drive device 208. Alternatively, various programs to be installed in the auxiliary storage device 204 may be installed by being downloaded from the network via the communication device 207.

### Flow of Execution Order Determining Process

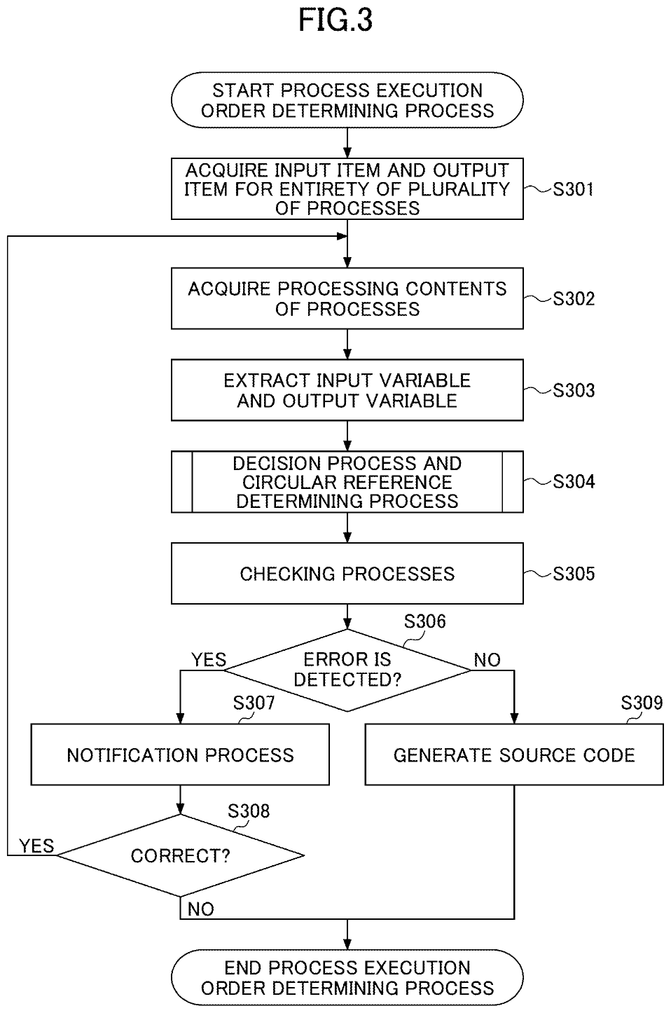

Next, a flow of an execution order determining process performed by the process execution order determining unit 121 will be described. FIG. 3 is a flowchart illustrating the flow of the execution order determining process. In response to an instruction from the user 130, the process execution order determining unit 121 is started, and in doing so, the execution order determining process illustrated in FIG. 3 is executed.

In step S301, the process execution order determining unit 121 acquires an input item and an output item for the entirety of a plurality of processes (an example of a first acquiring process).

In step S302, the process execution order determining unit 121 acquires processing contents of each of the processes entered as descriptions by the user 130 (an example of a second acquiring process).

In step S303, the process execution order determining unit 121 extracts an input item included in each of the processes (a variable to be input into each of the processes, hereinafter referred to as an input variable) based on the acquired processing contents. In addition, the process execution order determining unit 121 extracts an output item included in each of the processes (a variable to be output from each of the processes, hereinafter referred to as an output variable) based on the acquired processing contents (an example of an extracting process).

In step S304, the process execution order determining unit 121 performs a decision process for determining the execution order of the plurality of processes (an example of a decision process). Further, the process execution order determining unit 121 performs a circular reference determining process (a first determination process) for determining whether there is a circular reference, which is an example of an inconsistency between processes. Details of the decision process and the circular reference determining process will be described later.

In step S305, after determining the execution order of the plurality of processes, the process execution order determining unit 121 is configured to perform:
a process for checking whether there is a conflict (an example of an inconsistency) between processes (an example of a second determination process); and
a process for checking whether there is an insufficiency (an example of an inconsistency) (an example of a third determination process).

Note that the process for checking whether there is a conflict refers to a process for checking whether any variable included in processing contents of the processes is updated by two or more processes under the same conditions (for example, in the same cycle and in the same execution mode) (details will be described later)).

The process for checking an insufficiency refers to a process for checking whether there is a variable that is not updated by any process from among variables included in the processing contents of the processes under the same conditions (for example, in the same cycle and in the same execution mode) (details will be described later)).

In step S306, the process execution order determining unit 121 determines whether an error is detected as a result of the checking processes performed in step S305. If the process execution order determining unit 121 determines that an error is detected in step S306 (YES in step S306), the process proceeds to step S307.

In step S307, the process execution order determining unit 121 performs a notification process (an example of a notification process) for notifying the user 130 of details of the detected error (notifying the user 130 that there is an error in the descriptions of processing contents of a corresponding process).

In step S308, the process execution order determining unit 121 determines whether a correction instruction is received from the user 130. If the process execution order determining unit 121 determines that a correction instruction is received in step S308 (YES in step S308), the process returns to step S302. Conversely, if the process execution order determining unit 121 determines that a correction instruction is not received in step S308 (NO in step S308), the process execution order determining unit 121 ends the execution order determining process.

If the process execution order determining unit 121 determines that an error is not detected in step S306 (NO in step S306), the process proceeds to step S309.

In step S309, the process execution order determining unit 121 generates a source code of each of the processes based on the determined execution order, and ends the execution order determining process.

### Outline of Execution Order Determining Process

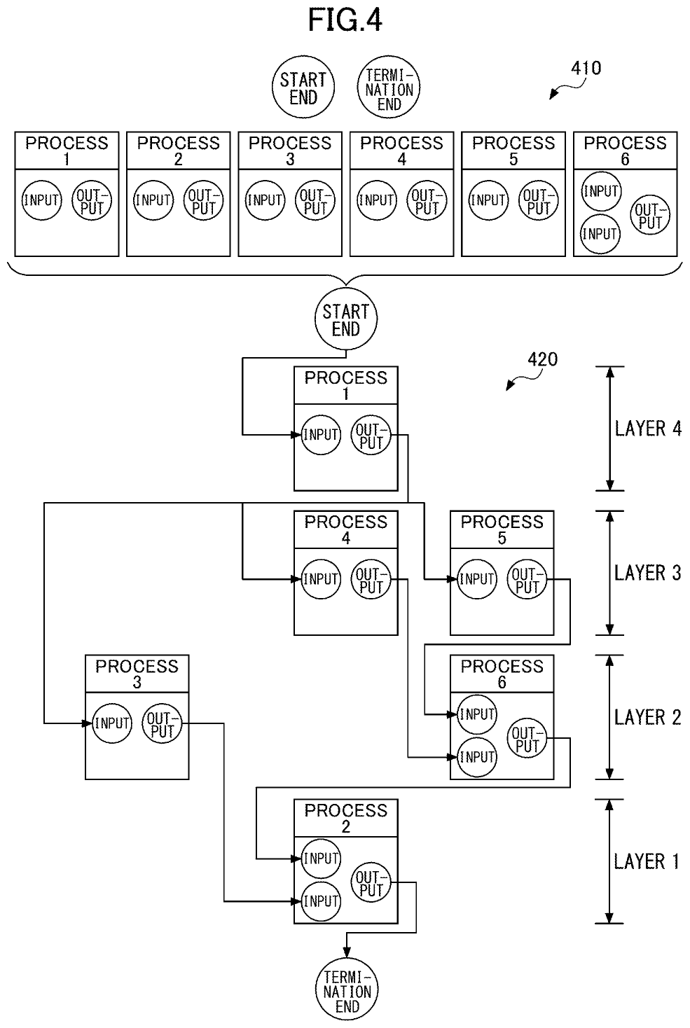

Next, an outline of the process execution order determining process performed by the process execution order determining unit 121 will be described. Note that in the following, the circular reference determining processing and the checking processes will not described, and only a process for associating processes with one another based on the input/output relationship will be described. FIG. 4 is a diagram illustrating an outline of the execution order determining process.

As illustrated in FIG. 4, first, the process execution order determining unit 121 acquires an input item (a start end) for the entirety of a plurality of processes and an output item (a termination end) for the entirety of the plurality of processes (see reference numeral 410). Subsequently, the process execution order determining unit 121 acquires processing contents of each of the processes (processes 1 to 6 in the example of FIG. 4) entered as descriptions by the user 130 (see reference numeral 410). In the following description, the term “process” refers to a group of processing contents entered as descriptions in a predetermined description frame by the user 130, as illustrated in the processes 1 to 6 in FIG. 4. The generation of a source code as described above is performed for each “process”.

Next, the process execution order determining unit 121 determines the execution order of the plurality of processes by extracting input variables and output variables from the processes and automatically analyzing the input/output relationship between the processes. Specifically, the process execution order determining unit 121 sequentially connects the processes in different layers by using the input variables and the output variables extracted from the processes, with the input item and the output item for the entirety of the plurality of processes being set as the start end and the termination end. Accordingly, the process execution order determining unit 121 automatically determines the execution order of the processes 1 to 6 (see reference numeral 420) by forming paths (connection paths) between the processes.

### Functional Configuration of Process Execution Order Determining Unit

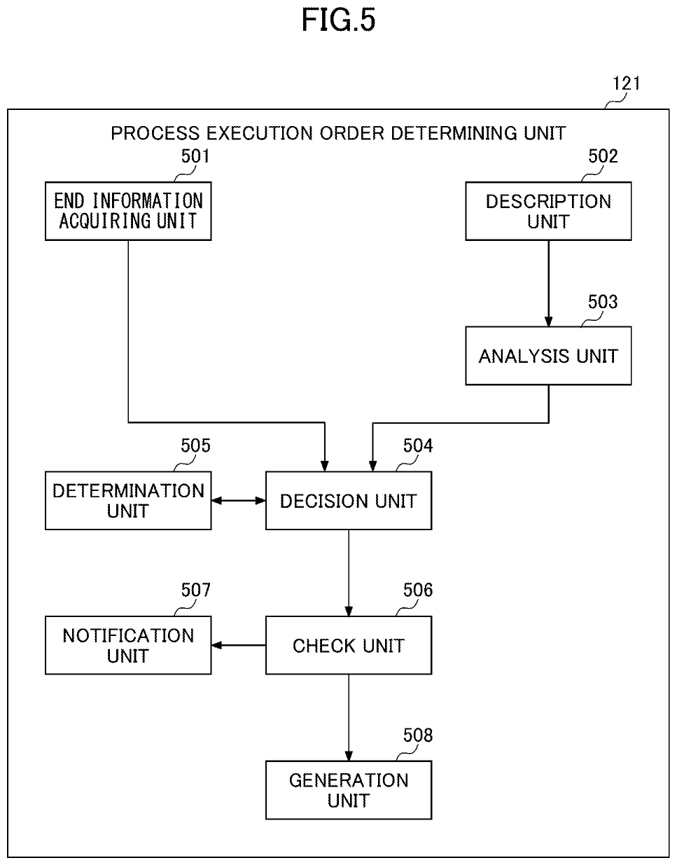

Next, a functional configuration of the process execution order determining unit 121 will be described. FIG. 5 is a diagram illustrating an example of a functional configuration of the process execution order determining unit. As illustrated in FIG. 5, the process execution order determining unit 121 includes an end information acquiring unit 501, a description unit 502, an analysis unit 503, a decision unit 504, a determination unit 505, a check unit 506, a notification unit 507, and a generation unit 508.

The end information acquiring unit 501 acquires an input item for the entirety of a plurality of processes and an output item for the entirety of the plurality of processes. Further, the end information acquiring unit 501 indicates the acquired input item and output item to the decision unit 504 as a start end and a termination end.

The description unit 502 acquires processing contents of the plurality of processes entered as descriptions by the user 130. The description unit 502 indicates the acquired processing contents of the plurality of processes to the analysis unit 503.

The analysis unit 503 analyzes the processing contents of the plurality of processes indicated by the description unit 502, and extracts input variables and output variables from the plurality of processes. Further, the analysis unit 503 identifies an “execution mode” indicating, from among a plurality of operation control modes included in the device system 10, an operation control mode in which each of the processes is executed upon transitioning to the operation control mode.

Note that the types of operation control modes included in the device system 10 are defined in advance, and each of processes describes an operation control mode in which each of the processes is executed upon transitioning to the operation control mode.

Further, the analysis unit 503 indicates the input variables and the output variables extracted from the plurality of processes and the execution modes identified for the respective processes to the decision unit 504.

The decision unit 504 determines the execution order of the plurality of processes by using the input variables and the output variables, extracted from the processes, to sequentially connect the processes in different layers so as to form paths, with the input item and the output item being set as the start end and the termination end as indicated by end information acquiring unit 501.

The determination unit 505 monitors elements (at least one of the processes and the variables) that appear in the paths, and determines whether there is a circular reference. The paths are formed by using the input variables and the output variables to connect the processes in different layers by the decision unit 504.

The “circular reference” refers to a situation in which the same elements appear in the same path multiple times. In the execution order determining process, if the same elements appear in the same path multiple times, the process would be repeated and would not be completed. Therefore, the determination unit 505 determines whether there is a circular reference. Note that the “same path” refers to a path formed by using input variables and output variables, extracted from the processes, to connect processes, and also refers to a single path connected toward a termination end (or toward a lower layer). In the example of FIG. 4, when viewed from a start end, each of the following three paths is formed as the same path. Note that, for simplicity of description, the input variables and output variables extracted for the processes are not depicted.
Start end→process 1→process 3→process 2→termination end
Start end→process 1→process 4→process 6→process 2→termination end
Start end→process 1→process 5→process 6→process 2→termination end

If the determination unit 505 determines that there is a circular reference, the decision unit 504 stops the execution order determining process, and notifies the user 130 of the determination result.

The check unit 506 performs the process for checking whether there is a conflict and the process for checking whether there is an insufficiency in a state in which the execution order of the plurality of processes is determined by the decision unit 504. When performing the process for checking whether there is a conflict and the process for checking whether there is an insufficiency, the check unit 506 refers to the execution modes of the respective processes and performs the checking processes for each of the execution modes.

If it is determined that an error is detected as a result of the checking processes performed by the check unit 506, the notification unit 507 notifies the user 130 of details of the detected error (notifies the user 130 that there is an error in the descriptions of processing contents of a corresponding process).

The generation unit 508 generates a source code of each of the processes, based on the execution order of the processes determined by the decision unit 504.

### Specific Examples of Processes Performed by Units

Next, specific examples of the respective units (the description unit 502, the analysis unit 503, the decision unit 504, the determination unit 505, the check unit 506, and the notification unit 507) included in the process execution order determining unit 121 will be described. In the following specific examples, the device system 10 is an air conditioning system, the devices A are compressors, the devices B are heat exchangers, and the devices C are indoor units.

### (1) Specific Example of Process Performed by Description Unit

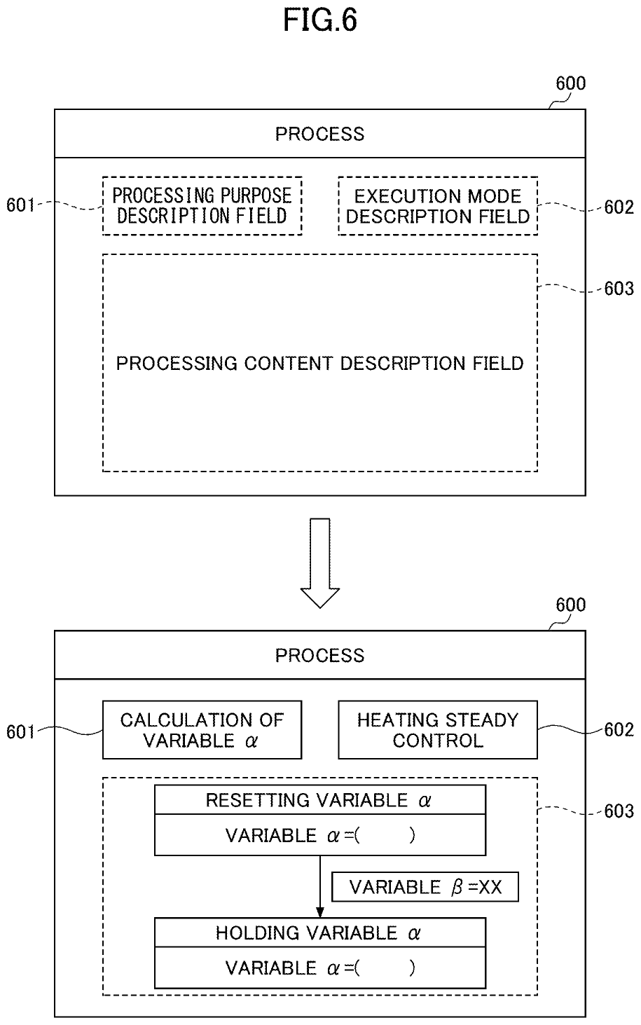

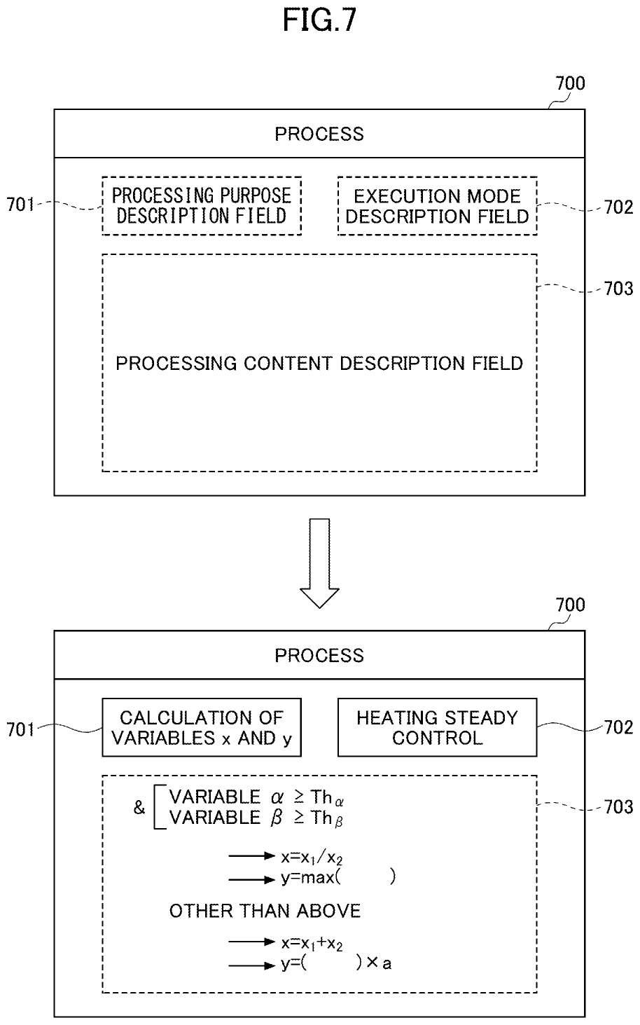

First, a specific example of a process performed by the description unit 502 will be described with reference to FIG. 6 and FIG. 7. FIG. 6 and FIG. 7 are first and second diagrams illustrating a specific example of a process performed by the description unit. As illustrated in FIG. 6 and FIG. 7, processing contents of a process entered as descriptions by the user 130 are arbitrary.

In the example illustrated in FIG. 6, a processing purpose of a process 600 is entered in a processing purpose description field 601, and an execution mode in which the process 600 is executed is entered in an execution mode description field 602.

Specifically, “calculation of variable α” is entered in the processing purpose description field 601, and “steady heating control” is entered in the execution mode description field 602.

In the example illustrated in FIG. 6, a state transition process is entered as processing contents of the process 600 in a processing content description field 603.

Specifically, in a reset state, a value indicated in “( )” is assigned to the variable α. In a holding state in which the variable α is held, a value indicated in “( )” (a value different from the value assigned in the reset state) is assigned to the variable α. The reset state transitions to the holding state on condition that the execution mode is the “steady heating control” mode and the value of a variable β is “XX”.

Accordingly, the user 130 can enter a state transition process as processing contents of a process to be executed in a predetermined execution mode.

Similarly, in the example of FIG. 7, processing purpose of a process 700 is entered in a processing purpose description field 601, and an execution mode in which the process 700 is executed is entered in an execution mode description field 602.

Specifically, “calculation of variables x and y” is entered in the processing purpose description field 701, and “steady heating control” is entered in the execution mode description field 702.

Further, in the example illustrated in FIG. 7, a conditional branch process is entered as processing contents of the process 700 in a processing content description field 703.

Specifically, in a case where the execution mode is the “steady heating control” mode, and the value of a variable α is greater than or equal to a threshold Th_{α} and the value of a variable β is greater than or equal to a threshold Th_{β}, x₁/x₂ is assigned to the variable X and the maximum value among values indicated in “( )” is assigned to the variable y. Further, in a case where the execution mode is the “steady heating control” mode, and the value of the variable α is not greater than or equal to the threshold Th_{α} or the value of the variable β is not greater than or equal to the threshold Th_{β}, x₁+x₂ is assigned to the variable X and a value obtained by multiplying a value indicated in “( )” by a coefficient a is assigned to the variable y.

Accordingly, the user 130 can enter a state transition process as processing contents of a process to be executed in a predetermined execution mode.

### (2) Specific Example of Process Performed by Analysis Unit

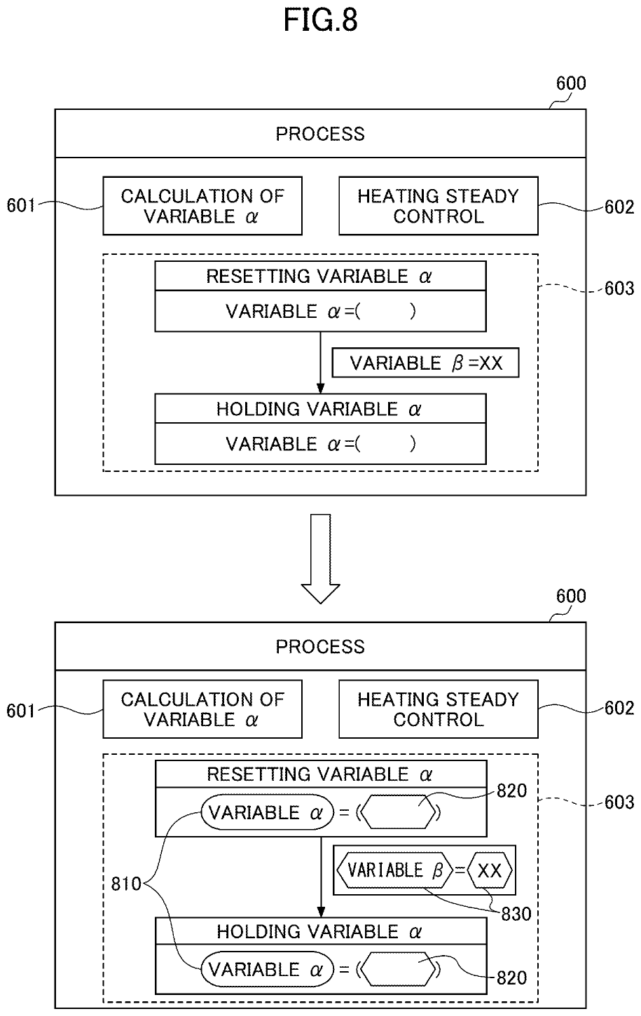

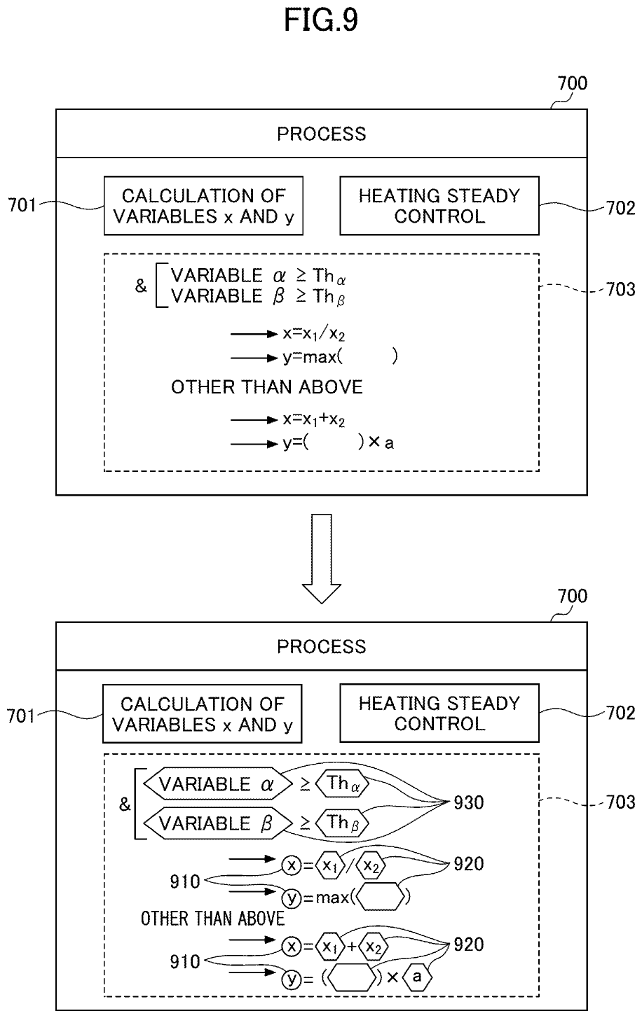

Next, a specific example of a process performed by the analysis unit 503 will be described with reference to FIG. 8 and FIG. 9. FIG. 8 and FIG. 9 are first and second diagrams illustrating a specific example of a process performed by the analysis unit. In FIG. 8 and FIG. 9, the process 600 and the process 700 illustrated FIG. 6 and FIG. 7 are analyzed as analysis targets.

For example, as illustrated in FIG. 8, the analysis unit 503 analyzes the processing content description field 603 of the process 600 indicated by the description unit 502, and identifies an assignment statement and a conditional statement. Further, the analysis unit 503 extracts the left-hand side of the identified assignment statement as an output variable (see reference numeral 810) and the right-hand side of the assignment statement as an input variable (reference numeral 820). Further, the analysis unit 503 extracts each of the left-hand side and the right-hand side of the identified conditional statement as an input variable (reference numeral 830). Further, the analysis unit 503 identifies the execution mode in which the process 600 is executed by referring to the execution mode description field 602.

Similarly, as illustrated in FIG. 9, the analysis unit 503 analyzes the processing content description field 703 of the process 700 indicated by the description unit 502, and identifies an assignment statement and a conditional statement. Further, the analysis unit 503 extracts the left-hand side of the identified assignment statement as an output variable (see reference numeral 910) and the right-hand side of the assignment statement as an input variable (reference numeral 920). Further, the analysis unit 503 extracts each of the left-hand side and the right-hand side of the identified conditional statement as an input variable (reference numeral 930). Further, the analysis unit 503 identifies the execution mode in which the process 700 is executed by referring to the execution mode description field 702.

### (3) Flow of Decision Process and Circular Reference Determining Process

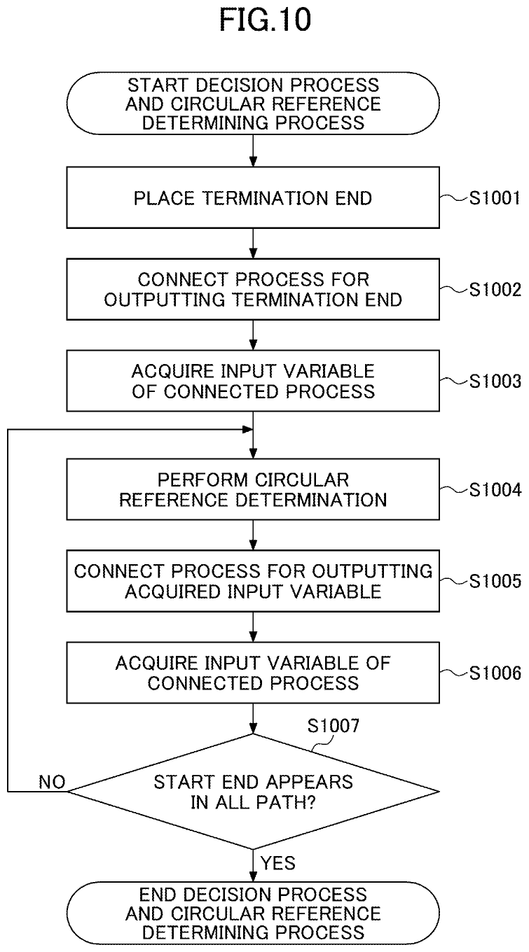

Next, a flow of the decision process and the circular reference determining process (step S304 of FIG. 3) performed by the decision unit 504 and the determination unit 505 will be described. FIG. 10 is a flowchart illustrating a flow of the decision process and the circular reference determining process.

In step S1001, the decision unit 504 places a termination end acquired from the end information acquiring unit 501 at a termination end position.

In step S1002, from among a plurality of processes whose processing contents are entered as descriptions by the description unit 502, the decision unit 504 identifies a process by which the termination end is output as an output variable, and connects the identified process to the termination end.

In step S1003, the decision unit 504 acquires, from the analysis unit 503, an input variable extracted from processing contents of the connected process.

In step S1004, the determination unit 505 determines whether there is a circular reference based on the input variable acquired from the analysis unit 503.

In step S1005, from among the plurality of processes whose processing contents are entered as descriptions by the description unit 502, the decision unit 504 identifies a process by which the input variable acquired from the analysis unit 503 is output as an output variable, and connects the identified process.

In step S1006, the decision unit 504 acquires, from the analysis unit 503, an input variable extracted from processing contents of the connected process.

In step S1007, the decision unit 504 determines whether a start end appears in all paths. If the decision unit 504 determines that there is a path in which the start end does not appear in step

S1007 (NO in step S1007), the process returns to step S1004.

Conversely, in step S1007, if the decision unit 504 determines that the start end appears in all paths (YES in step S1007), the decision unit 504 ends the determination process and the circular reference determining process.

### (4) Specific Example of Process Performed by Decision Unit

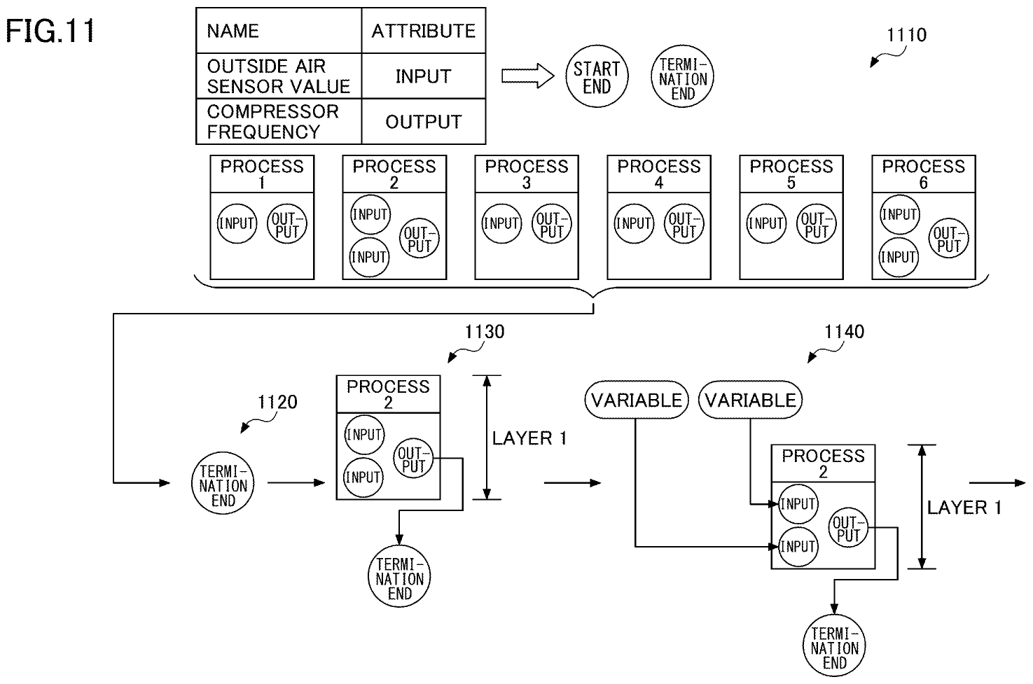

Next, a specific example of a process performed by the decision unit 504 will be described. Note that the circular reference determining process by the determination unit 505 is not depicted. FIG. 11 through FIG. 13 are first to third diagrams illustrating a specific example of a process performed by the decision unit.

In FIG. 11, reference numeral 1110 indicates a specific example in which the decision unit 504 acquires a start end (an outside air sensor value) and a termination end (a compressor frequency) from the end information acquiring unit 501, and processes (processes 1 to 6) whose processing contents are entered as descriptions by the description unit 502.

First, the decision unit 504 places the termination end acquired from the end information acquiring unit 501 at a termination end position (see reference numeral 1120). Subsequently, the decision unit 504 identifies the process 2 as a process by which the termination end is output as an output variable, and places the identified process 2 in layer 1, and connects the process 2 to the termination end (see reference numeral 1130).

Next, the decision unit 504 acquires input variables extracted from processing contents of the process 2. In the example illustrated in F the decision unit 504 acquires two input variables (see reference numeral 1140).

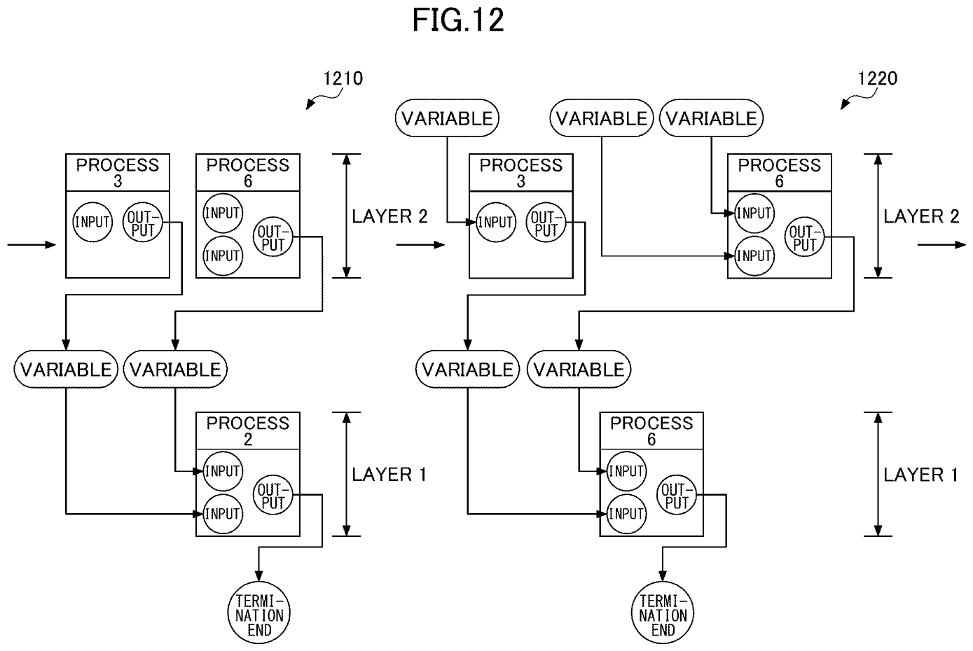

Next, as illustrated in FIG. 12, the decision unit 504 identifies the process 3 and the process 6 as processes by which the respective input variables of the process 2 are output as output variables. Further, the decision unit 504 places the identified process 3 and process 6 in layer 2, and connects the identified process 3 and process 6 to the process 2 (see reference numeral 1210).

Next, the decision unit 504 acquires input variables extracted from processing contents of the process 3 and process 6. In the example illustrated in FIG. 12, the decision unit 504 acquires one input variable from the process 3 and acquires two input variables from the process 6 (see reference numeral 1220).

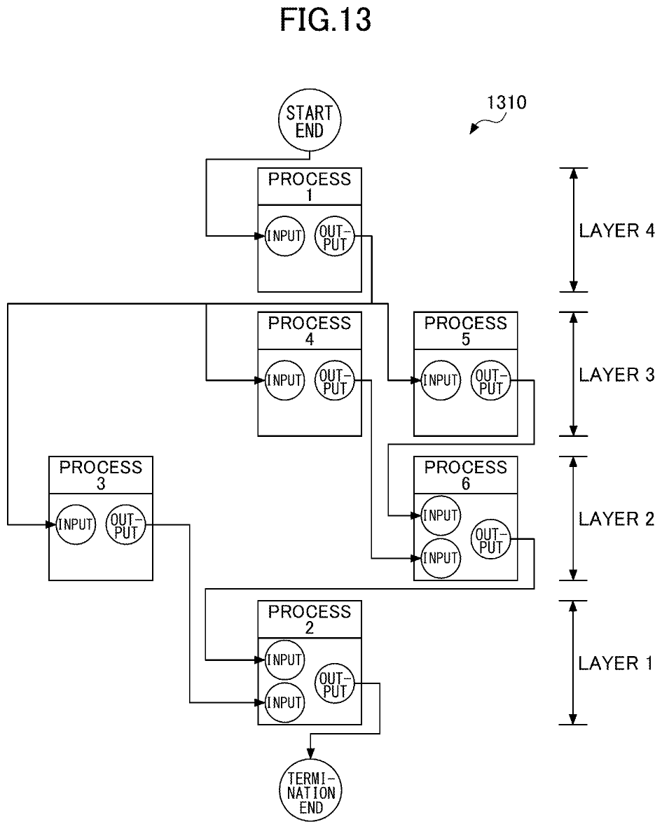

The decision unit 504 reaches the start end by repeating the above-described process. In FIG. 13, reference numeral 1310 indicates that the decision unit 504 has reached the start end. Accordingly, the decision unit 504 can determine the execution order of a plurality of processes by acquiring input variables and output variables extracted from the plurality of processes, and connecting the processes in different layers so as to form paths (automatically analyzing the input/output relationship between the processes).

### (5) Specific Example of Process Performed by Determination Unit

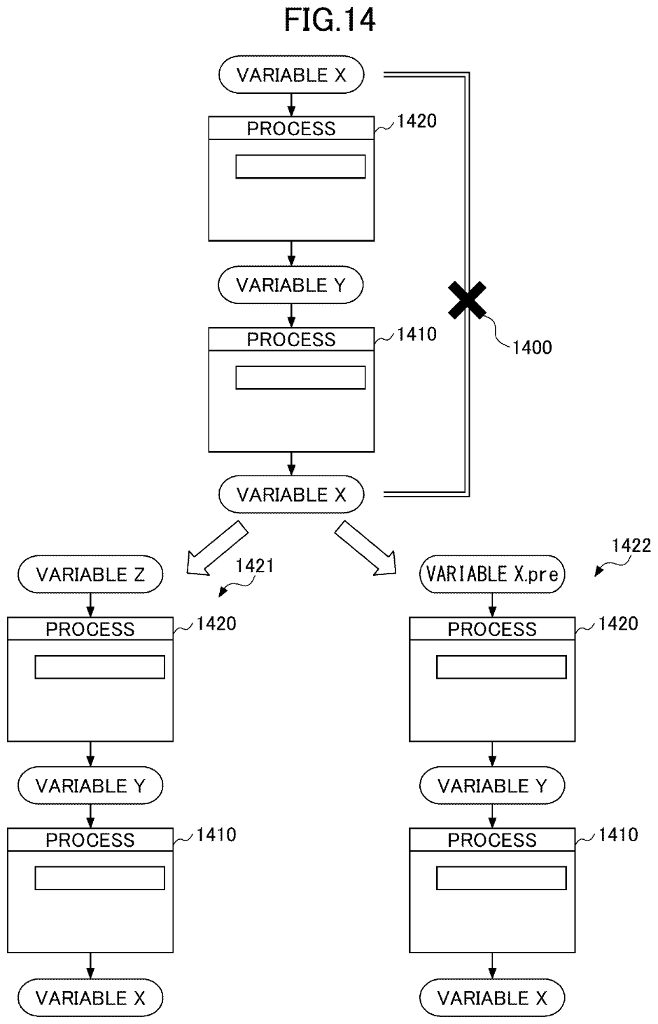

Next, a specific example of a process performed by the determination unit 505 will be described. FIG. 14 is a diagram illustrating a specific example of a process performed by the determination unit. For simplicity of description, a specific example of a process performed by the determination unit 505 when the decision unit 504 determines the execution order of specific two processes from among a plurality of processes will be described.

As illustrated in FIG. 14, it is assumed that a process 1420 is connected to a process 1410 by the decision unit 504. The process 1420 outputs a variable Y as a variable to be input into the process 1410, and the process 1410 outputs a variable X as an output variable. Further, it is assumed that processing contents of the process 1420 are analyzed by the analysis unit 503 and the variable X is extracted as an input variable to be input into the process 1420.

In this case, the determination unit 505 determines whether there is a circular reference by monitoring whether the same variable as the variable

X (for example, the variable having the same variable name as the variable X), which is to be input into the process 1420, appears in the same path. In the example illustrated in FIG. 14, two variables X appear in the same path (variable X→process 1420→variable Y→process 1410→variable X). Therefore, the determination unit 505 determines that there is a circular reference (there is an inconsistency between the processes) (see a cross mark indicated by 1400). In addition, the determination unit 505 causes the execution order determining process to stop, and notifies the user 130 of the determination result.

As described, the determination unit 505 determines whether there is a circular reference each time the decision unit 504 connects processes by using input variables and output variables. Accordingly, the determination unit 505 can avoid a situation in which the decision process performed by the decision unit 504 is repeated and is not completed.

If the determination unit 505 determines that there is a circular reference, the user 130 corrects a corresponding process to eliminate the inconsistency between the processes. For example, the user 130 corrects the processing contents of the process 1420 by changing the input variable from the variable X to a variable Z. Accordingly, a situation in which the same variables (variables having the same variable name) appear in the same path can be avoided (see reference numeral 1421).

Alternatively, the user 130 corrects the processing contents of the process 1420 by changing the input variable from the variable X in the same loop to a variable X in the previous loop. In FIG. 14, reference numeral 1422 indicates that “variable X.pre”, which is to be input into the process 1420 as an input variable, is a variable X in the previous loop. Accordingly, a situation in which the same variables (variables having the same variable name) appear in the same path can be avoided (see reference numeral 1422).

### (6) Specific Example of Process Performed by Check Unit

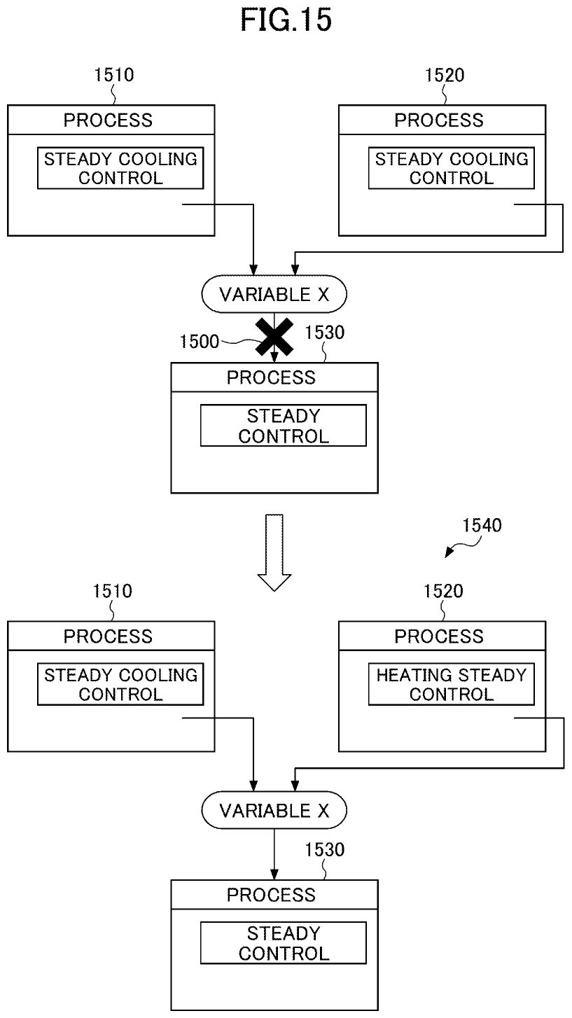

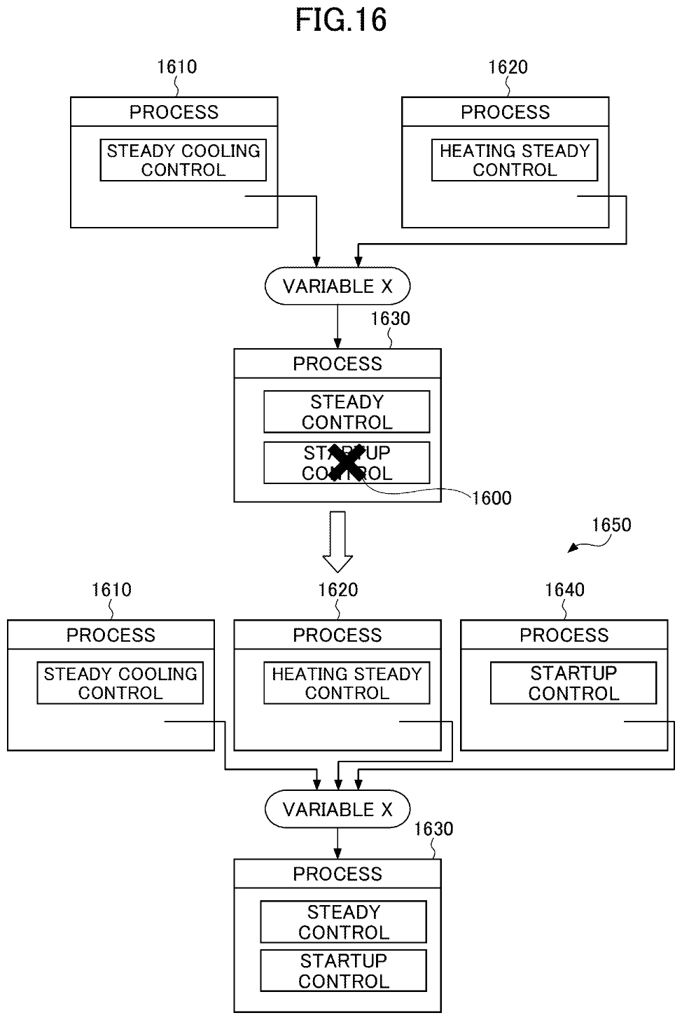

Next, a specific example of a process performed by the check unit 506 will be described. FIG. 15 and FIG. 16 are first and second diagrams illustrating a specific example of a process performed by the check unit.

FIG. 15 illustrates a state in which the process for checking whether there is a conflict is performed by the check unit 506. In the example illustrated in FIG. 15,
the analysis unit 503 analyzes processing contents of a process 1530, and extracts a variable X as an input variable to be input into the process 1530;
the decision unit 504 identifies a process 1510 and a process 1520, by each of which the variable X is output as an output variable, and connects the process 1510 and the process 1520 to the process 1530; and
the analysis unit 503 identifies that the execution mode of each of the process 1510 and the process 1520 connected by the decision unit 504 is a “steady cooling control” mode.

In this case, the check unit 506 determines that the input variable (“variable X”) included in the processing contents of the process 1530 is updated by the two processes 1510 and 1520 under the same conditions (in the same cycle and in the same “steady cooling control” mode) as those of the process 1530. That is, the check unit 506 determines that there is an inconsistency between the processes. As a result, the check unit 506 detects a conflict error (see a cross mark indicated by 1500).

If a conflict error is detected by the check unit 506, the user 130 corrects a corresponding process to eliminate an inconsistency between the processes. For example, the user 130 corrects the execution mode description field of the process 1520 by changing “steady cooling control” to “steady heating control”. Accordingly, a situation (conflict error) in which the input variable included in the processing contents of the process is updated by the two or more processes under the same conditions can be avoided (see reference numeral 1540).

FIG. 16 illustrates a state in which the process for checking whether there is an insufficiency is performed by the check unit 506. In the example illustrated in FIG. 16,
the analysis unit 503 analyzes processing contents of a process 1630, and identifies that the process 1630 is executed in “steady control” mode and in “startup control” mode;
the analysis unit 503 analyzes the processing contents of the process 1630, and extracts a variable X as an input variable to be input into the process 1630;
the decision unit 504 identifies a process 1610 and a process 1620, by each of which the variable X is output as an output variable, and connects the process 1610 and the process 1620 to the process 1630; and
the analysis unit 503 identifies that the execution mode of each of the process 1610 and the process 1620 connected by the decision unit 504 is the “steady control” mode (although there is a difference between “cooling” and “heating”, both the process 1610 and the process 1620 are executed in “steady control” mode.).

In this case, the check unit 506 determines that the input variable (“variable X”) included in the processing contents of the process 1630 is not updated by any process under the same conditions (in the same cycle and in the same “startup control” mode) as those of the process 1630. That is, the check unit 506 determines that there is an inconsistency between the processes. As a result, the check unit 506 detects an insufficiency error (see a cross mark indicated by 1600).

If an insufficiency error is detected by the check unit 506, the user 130 adds a corresponding process to eliminate an inconsistency between the processes. For example, the user 130 adds a process 1640. The process 1640 is a process by which the variable X is output as an output variable and that is executed in “startup control” mode. Accordingly, a situation (an insufficiency error) in which the input variable included the processing contents of the process is not updated by any process under the same conditions can be avoided (see reference numeral 1659).

### (7) Specific Example of Process Performed by Notification Unit

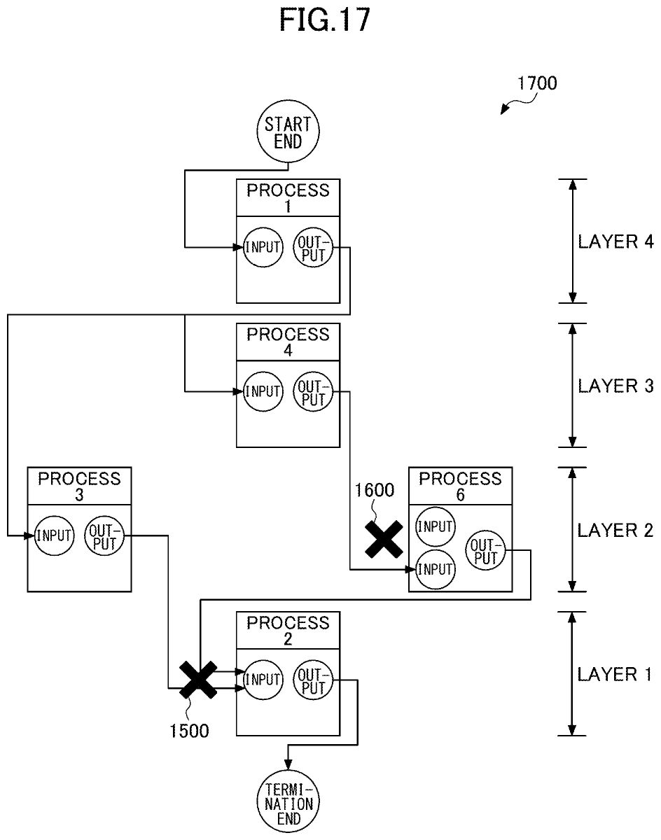

Next, a specific example of a process performed by the notification unit will be described. FIG. 17 is a diagram illustrating a specific example of a process performed by the notification unit. In FIG. 17, a reference numeral 1700 indicates a state in which the execution order of processes is determined by the decision unit 504, and the process for determining whether there is a conflict and the process for determining whether there is an insufficiency are performed by the check unit 506.

Specifically, a conflict error is detected for the process 2 and is notified to the user 130 (see a cross mark indicated by 1500). In addition, an insufficiency error is detected for the process 6 and is notified to the user 130.

As described above, the check unit 506 checks whether there is a conflict and whether there is an insufficiency. If an error is detected, the notification unit 507 explicitly indicates a process for which the error is detected from among processes arranged in the determined execution order. Accordingly, the user can easily grasp which processes have an inconsistency.

### Summary

As is clear from the above description, the process execution order determining program according to the first embodiment causes a computer to execute:
a process for determining the execution order of a plurality of processes to be executed in controlled devices; and
a process for monitoring elements that appear in a connection path formed in the process for determining the execution order, and determining whether the same elements appear in the connection path.

Accordingly, the process execution order determining program according to the first embodiment allows the user to easily grasp whether the processes are associated with one another without any inconsistency based on a conflict check and an insufficiency check.

Further, the process execution order determining program according to the first embodiment causes the computer to execute:
a process for determining whether any variable included in processing contents of processes is updated by two or more processes; and
a process for determining whether there is a variable that is not updated by any process from among the variables included in the processing contents of the processes.

Accordingly, the process execution order determining program according to the first embodiment allows the user to easily grasp whether the processes are associated with one another without any inconsistency based on a conflict check and an insufficiency check.

That is, according to the first embodiment, it is possible to support work in determining the execution order of a plurality of processes when designing the plurality of processes to be executed in controlled devices.

### Second Embodiment

In the above-described first embodiment, when the analysis unit 503 extracts input and output variables from each process, the analysis unit 503 identifies an assignment statement and a conditional statement, extracts the left-hand side of the assignment statement as an output variable, extracts the right-hand of the assignment statement as an input variable, and extracts each of the left-hand side and right-hand side of the conditional statement as an input variable. However, an extraction algorithm for extracting input and output variables from each process is not limited thereto, and input and output variables may be extracted based on any other extraction algorithm.

Further, in the above-described first embodiment, as a specific example, the determination unit 505 determines whether there is a circular reference by monitoring whether the same variables appear in the same path. However, the determination unit 505 may determine whether there is a circular reference by monitoring whether the same elements (the same processes) appear in the same path.

Further, in the above-described first embodiment, when the determination unit 505 determines whether there is a circular reference and when the check unit 506 determines whether there is a conflict, a determination as to whether the same variables appear is made based on a variable name. However, when the determination unit 505 determines whether there is a circular reference and when the check unit 506 determines whether there is a conflict, attribute information other than the variable name may be used to make a determination as to whether the same variables appear.

Further, in the above-described first embodiment, when the notification unit 507 notifies the user 130 of details of an error (notifies the user 130 that there is an error in the descriptions of processing contents of a corresponding process), the notification unit 507 explicitly indicates the process for which the error is detected from among processes arranged in the determined execution order. However, a method for explicitly notifying the details of the error is not limited thereto. For example, the notification unit 507 may notify the user of a statement that, for example, “there are multiple processes that calculate a variable X and that are executed in the same execution mode. Specifically, the multiple processes are processes 3 and 6”. Further, a method for explicitly indicates the process for which the error is detected from among the processes arranged in the determined execution order is not limited to the example illustrated in FIG. 17, and the process may be explicitly indicated in any other manner.

Further, in the above-described first embodiment, an insufficiency is checked based on variables included in processing contents of processes. However, from among the variables included in the processing contents of the processes, a variable that serves as a start end is not updated by any process. Therefore, it is assumed that the check unit 506 is configured to exclude the variable serving as the start end from the variables included in the process contents of the processes, and check an insufficiency.

Further, in the above-described first embodiment, as a specific example, processes whose processing contents are entered as descriptions have been described. However, the types of processes are not limited thereto, and a process for determining an operation control mode (an operation control mode determining process) may be included, for example.

The operation control mode determining process determines an operation control mode from among a plurality of predetermined operation control modes based on an input (for example, a heating instruction or a cooling instruction from a remote control) relating to the transition to the operation control mode.

If the operation control mode determining process is incorporated at a location in a path between a start end and a termination end when the execution order of processes is determined, the processes operate as follows.
A process disposed on the start end side relative to the operation control mode determining process operates in operation control mode determined by an operation control mode determining process in the previous loop.
A process disposed on the termination end side relative to the operation control mode determining process operates in operation control mode determined by the current operation control mode determining process.

Therefore, even if the same variables appear at the start end side and at the termination end side of the operation control mode determining process, the determination unit 505 does not determine that there is a circular reference.

### Third Embodiment

In the above-described first and second embodiments, the execution order is determined by using input variables and output variables, extracted from a plurality of processes, to connect the processes so as to form connection paths. However, a method for determining the execution order is not limited thereto, and the execution order may be determined by, for example, using graph theory to identify the connection relationships between the processes. In the third embodiment, differences from the first and second embodiments will be mainly described.

### Outline of Graph Theory

First, an outline of graph theory will be described. Graph theory is a theory for studying the properties of graphs consisting of vertices and edges connecting the vertices.

According to graph theory,
a plurality of processes, and
variables (input variables and output variables) included in processing contents of the plurality of processes are regarded as vertices, and
the relationships between the processes and the input variables that are input to the processes, and
the relationships between the processes and the output variables that are output from the processes are regarded as edges (directed edges).
Accordingly, the relationship between the plurality of processes and the variables included in the processing contents of the plurality of processes can be regarded as a matrix (specifically, an adjacency matrix of a directed graph).

The connection relationship between vertices can be analyzed by calculating the power of the adjacency matrix of the directed graph. For example, the connection relationship between processes through a variable can be identified by calculating the square of the adjacency matrix of the directed graph.

### Specific Example of Process for Identifying Connection Relationship between Processes

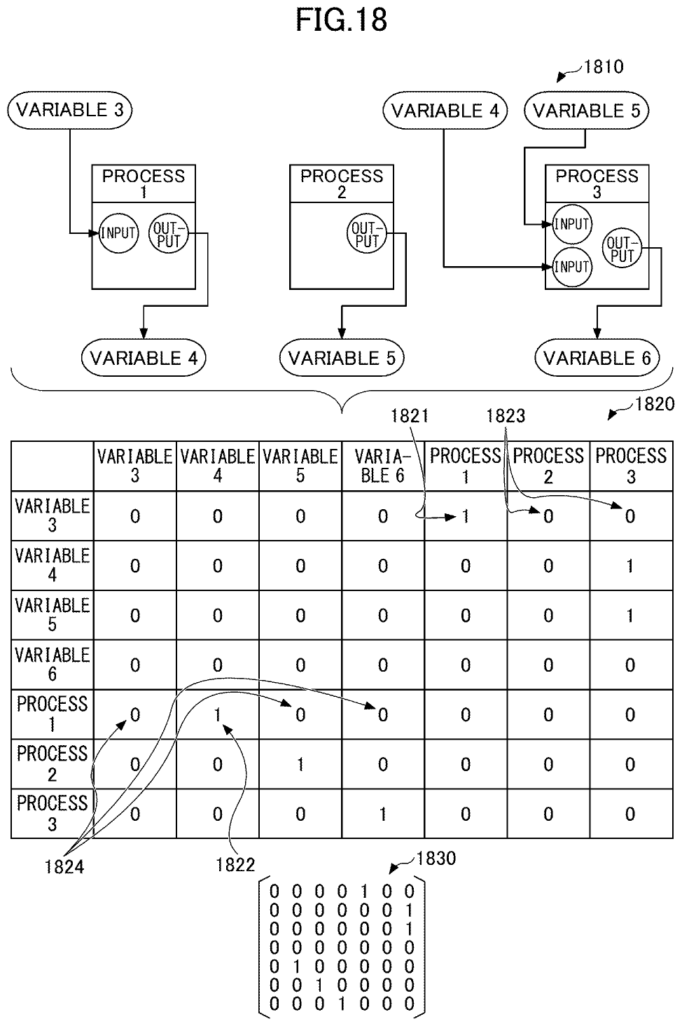

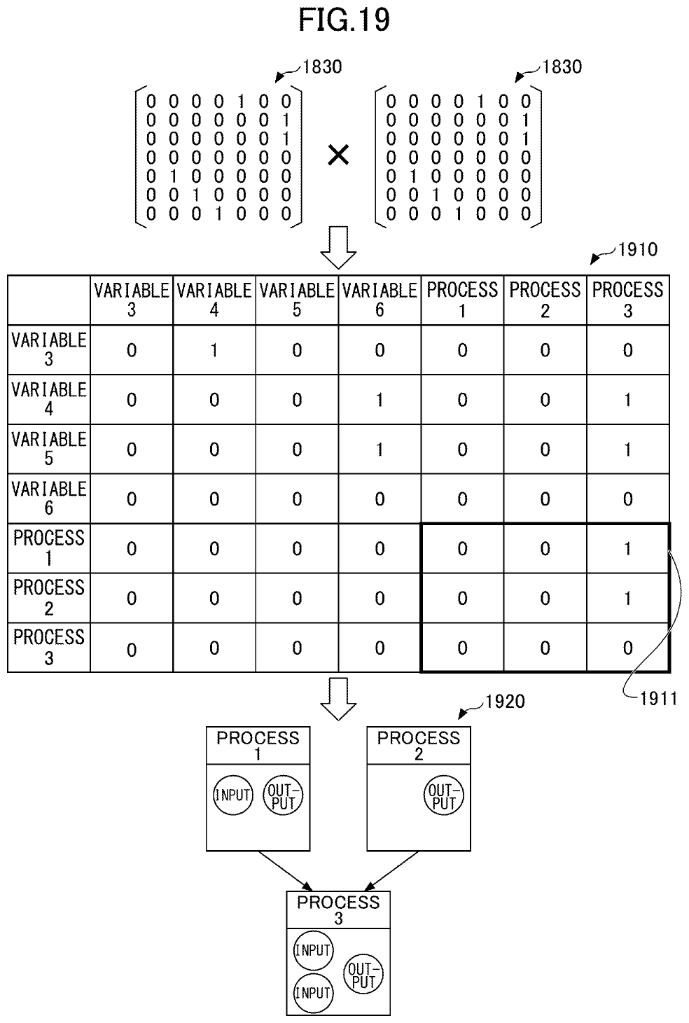

Next, a specific example of a process for identifying the connection relationship between processes by using graph theory will be described. FIG. 18 and FIG. 19 are first and second diagrams illustrating a specific example of a process for identifying the connection relationship between processes.

In FIG. 18, reference numeral 1810 indicates processing contents of processes (processes 1 to 3 in the example of FIG. 18) entered as descriptions by the user 130.

In the present embodiment, the analysis unit 503 of the process execution order determining unit 121 acquires the processing contents of the processes, and extracts input variables and output variables included in the processes. Next, the decision unit 504 of the process execution order determining unit 121 generates a table 1820 indicating the input/output relationships between the extracted input and output variables and the processes.

As indicated in table 1820, the decision unit 504 arranges the input variables (“variable 3”, “variable 4”, and “variable 5”), the output variables (“variable 4”, “variable 5”, and “variable 6”), and the processes (“process 1”, “process 2”, and “process 3”) in the row direction. That is, vertices in graph theory are arranged in the row direction.

Similarly, the decision unit 504 arranges the input variables (“variable 3”, “variable 4”, and “variable 5”), the output variables (“variable 4”, “variable 5”, and “variable 6”), and the processes (“process 1”, “process 2”, and “process 3”) in the column direction. That is, vertices in the graph theory are arranged in the column direction.

In the table 1820, “1” (a value indicating that there is a directed edge) is stored in an area where an item arranged in the row direction and an item arranged in the column direction intersect each other if the following relations are satisfied:
an item arranged in the column direction=an input target element, and an item arranged in the row direction=an element into which the input target is input, or
an item arranged in the column direction=an output source element, and an item arranged in the row direction=an element output from the output source.

Further, in the table 1820, “0” (a value indicating that there is no directed edge) is stored in an area where an item arranged in the row direction and an item arranged in the column direction intersect each other if the following relations are not satisfied:
an item arranged in the column direction=an input target element, and an item arranged in the row direction=an element into which the input target is input, and
an item arranged in the column direction=an output source element, and an item arranged in the row direction=an element output from which the output source.

For example, “variable 3” arranged in the column direction and “process 1” arranged in the row direction satisfy the relations of “variable 3”=“an input target element” and “process 1”=“an element into which the input target is input”. Therefore, “1” is stored in an area (area 1821) where “variable 3” arranged in the column direction intersects “process 1” arranged in the row direction.

Similarly, “process 1” arranged in the column direction and “variable 4” arranged in the row direction satisfies the relations of “process 1”=“an output source element” and “variable 4” =“an element output from which the output source”. Therefore, “1” is stored in an area (area 1822) where “process 1” arranged in the column direction intersects “variable 4” arranged in the row direction.

Conversely, “variable 3” arranged in the column direction and “process 2” and “process 3” arranged in the row direction do not satisfy the relations of “variable 3” =“an input target element” and each of “process 2” and “process 3”=“an element into which the input target is input”. Therefore, “0” is stored in an area (area 1823) where “variable 3” arranged in the column direction intersects each of “process 2” and “process 3” arranged in the row direction.

Similarly, for example, “process 1” arranged in the column direction and “variable 3”, “variable 5”, and “variable 6” arranged in the row direction do not satisfy the relations of “process 1”=“an output source element” and each of “variable 3”, “variable 5”, and “variable 6”=“an element output from the output source”. Therefore, “0” is stored in an area (area 1824) where “process 1” arranged in the column direction intersects each of “variable 3”, “variable 5”, and “variable 6” arranged in the row direction.

Next, the decision unit 504 of the process execution order determining unit 121 creates a matrix 1830 based on the generated table 1820. The matrix 1830 is a matrix (an adjacent matrix of a directed graph in graph theory) in which the values (“0” and “1”) stored in the areas of the table 1820 are arranged without change.

Next, as illustrated in FIG. 19, the decision unit 504 of the process execution order determining unit 121 calculates the square of the matrix 1830, and stores the calculation results in a table 1910. In the table 1910, items arranged in the row direction and items arranged in the column direction are the same as those arranged in the table 1820.

Note that a calculation result obtained by calculating the square of the matrix 1830 indicates the connection relationship between two processes connected through a variable.

For example, an area group 1911 indicates whether any of “process 1”, “process 2”, and “process 3” are connected to any of “process 1”, “process 2”, and “process 3” through variables.

Specifically, as a calculation result, “1” is stored in an area where “process 1” arranged in the column direction intersects “process 3” arranged in the row direction. Therefore, “process 1” and “process 3” are connected through a variable (specifically, through “variable 4”).

Similarly, as a calculation result, “1” is stored in an area where “process 2” arranged in the column direction intersects “process 3” arranged in the row direction. Therefore, “process 2” and “process 3” are connected through a variable (specifically, through “variable 5”).

Conversely, as a calculation result, “0” is stored in any other area of the area group 1911. Therefore, there is no connection between any other combination of the processes.

Next, the decision unit 504 of the process execution order determining unit 121 determines the execution order of the processes based on the connection relationships in the area group 1911.

In FIG. 19, reference numeral 1920 indicates the connection relationships between the processes identified by the area group 1911 of the table 1910.

In the present embodiment, a graph in which a plurality of processes are regarded as vertices and the relationships between the processes and variables are regarded as directed edges is used, and the decision unit 504 of the process execution order determining unit 121 determines the execution order of the plurality of processes by applying a sorting method, such as a topological sort, to the graph.

### Summary

As is clear from the above description, the process execution order determining program according to the third embodiment:
creates a matrix indicating the relationship between a plurality of processes and variables included in processing contents of the plurality of processes; and
determines the execution order of the plurality of processes based on the connection relationships between processes through variables identified from calculation results of the power of the created matrix.

Accordingly, in the process execution order determining program according to the third embodiment, the same effect as that of the first embodiment can be obtained, and further, the calculation cost for determining the execution order of processes can be reduced.

Although embodiments have been described above, it will be understood that various modifications may be made to the configurations and details thereof without departing from the spirit and scope of the claims.

This application is based on and claims priority to Japanese Patent Application No. 2020-062593, filed on Mar. 31, 2020, the entire contents of which are incorporated herein by reference.

DESCRIPTION OF THE REFERENCE NUMERALS
10 device system
110 design work support apparatus
120 design work support function
121 process execution order determining unit
501 end information acquiring unit
502 description unit
503 analysis unit
504 decision unit
505 determination unit
506 check unit
507 notification unit
508 generation unit
600, 700 process
601, 701 processing purpose description field
602, 702 execution mode description field
603, 703 processing content description field
1400 cross mark
1500, 1600 cross mark the decision process, and determining whether same elements appear in the connection path.

1. A non-transitory recording medium having stored therein a process execution order determining program for causing a computer to execute:
a decision process for determining an execution order of a plurality of processes to be executed in controlled devices; and
a first determination process for monitoring elements that appear in a connection path formed in the decision process, and determining whether same elements appear in the connection path.

2. The non-transitory recording medium according to claim 1, wherein the elements include either the processes or variables, the variables being included in processing contents of the processes.

3. The non-transitory recording medium according to claim 1, wherein the decision process includes determining the execution order by using input variables and output variables to connect the plurality of processes so as to form the connection path with an input item and an output item for an entirety of the plurality of processes being set as a start end and a termination end, the input variables and output variables being extracted from the plurality of processes.

4. The non-transitory recording medium according to claim 1, wherein the decision process includes creating a matrix indicating a relationship between the plurality of processes and variables included in processing contents of the plurality of processes, identifying a connection relationship between processes through a variable from a calculation result of the power of the matrix, and determining the execution order based on the connection relationship.

5. The non-transitory recording medium according to claim 4, wherein the matrix is an adjacency matrix of a directed graph in a case where the plurality of processes and the variables included in the processing contents of the plurality of processes are regarded as vertices in graph theory, and input and output relationships between the processes and the variables included in the processes are regarded as directed edges.

6. The non-transitory recording medium according to claim 1, wherein the first determination process includes indicating a determination result in response to determining that the same elements appear in the connection path.

7. The non-transitory recording medium according to claim 3, further causing the computer to execute
a first acquiring process for acquiring the input item and the output item for the entirety of the plurality of processes,
a second acquiring process for acquiring processing contents of the plurality of processes, and
an extracting process for extracting the input variables and the output variables from the processing contents of the plurality of processes acquired in the second acquiring process.

8. The non-transitory recording medium according to claim 3, further causing the computer to execute
a second determination process for determining whether a given variable included in processing contents of the plurality of processes is updated by two or more processes, and
a notification process for sending a notification in response to determining that the given variable is updated by the two or more processes in the second determination process.

9. The non-transitory recording medium according to claim 3, further causing the computer to execute
a third determination process for determining whether there is a variable that is not updated by any of the processes from among variables included in processing contents of the processes, and
a notification process for sending a notification in response to determining that there is the variable that is not updated by any of the processes in the third determination process.

10. A process execution order determining method comprising:
a decision process for determining an execution order of a plurality of processes to be executed in controlled devices; and
a determination process for monitoring elements that appear in a connection path formed in the decision process, and determining whether same elements appear in the connection path.
